(19) United States
(12) Patent Application Publication
(10) Pub. No.: US 2006/0195316 A1
(43) Pub. Date: Aug. 31, 2006

(54) Voice detecting apparatus, automatic image pickup apparatus, and voice detecting method

(75) Inventor: Yohei Sakuraba, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-Ku (JP)

(21) Appl. No.: 11/319,470

(22) Filed: Dec. 29, 2005

(30) Foreign Application Priority Data
Jan. 11, 2005 (JP) P2005-003761

(51) Int. Cl. G10L 11/06

(52) U.S. Cl. 704/208

(57) ABSTRACT

A voice detecting apparatus includes a first determining unit to determine that human voice has been input if a signal component having a harmonic structure is detected from an input voice signal; a second determining unit to determine that human voice has been input if a frequency center-of-gravity of the input voice signal is within a predetermined range; a noise level storing unit to store a noise level; a third determining unit to determine that human voice has been input if the ratio of the power of the input voice signal to the noise level is above a predetermined threshold; a final determining unit configured to finally determine whether human voice has been input based on determination results of the first to third determining units; and a noise level updating unit configured to update the noise level if the final determining unit determines that human voice has not been input.

### CROSS REFERENCES TO RELATED APPLICATIONS

The present invention contains subject matter related to Japanese Patent Application JP 2005-003761 filed in the Japanese Patent Office on Jan. 11, 2005, the entire contents of which are incorporated herein by reference.

### BACKGROUND OF THE INVENTION

1. Field of the Invention

The present invention relates to a voice detecting apparatus and method for detecting whether human voice has been input based on an input voice signal, and to an automatic image pickup apparatus using the voice detecting apparatus.

2. Description of the Related Art

As a system operating in response to voice input through a microphone or the like, there are suggested a voice recorder to automatically start recording upon detecting voice input by speech; and a system of switching cameras or directing a camera in accordance with the position of a person or an object that generated a sound. Such a system is particularly desired to reliably detect only a specific component, such as human voice, and not to wrongly operate in response to other noise.

The most typical method for detecting a voice input caused by speech is a method of distinguishing human voice from noise based on the power of input voice. For example, in a known method, the value of a noise level is updated as needed in accordance with an input power value so that a present noise level is stored. Then, whether the input voice is human voice or noise is determined based on the S/N (signal/noise) ratio between the stored noise level and the input voice.

Also, as a method for detecting a voice input with higher accuracy, a method using an autocorrelation value of an input voice signal and LPC (linear predictive coding) has been known. For example, U.S. Pat. No. 4,920,568 (FIG. 2 and so on) discloses the following voice interval determining method. That is, an autocorrelation coefficient is calculated based on a sampling value of input voice and a linear predictive coefficient is also calculated so as to obtain a cepstrum coefficient. Then, a vowel interval in the input voice is detected based on the cepstrum coefficient and the power value of the input voice signal. On the other hand, U.S. Pat. No. 6,031,915 (FIG. 7 and so on) discloses a voice start recording apparatus. In this apparatus, an input voice signal is vector-quantized by using an LPC synthetic filter in order to extract a predicted waveform pattern. Then, a residual signal of the predicted waveform pattern and a voice signal in a predetermined interval is obtained to calculate mutual correlation between the residual signal and the voice signal. Accordingly, voice is detected.

### SUMMARY OF THE INVENTION

However, in the above-described detecting method of updating the noise level as needed based on the power of input voice, a signal of high-power noise is wrongly determined to be human voice. Further, since the noise level is constantly updated in accordance with an input power, the noise level becomes the same as the level of input voice if voice input caused by speech continues, and thus the voice is wrongly determined to be noise disadvantageously.

On the other hand, in the detecting method using an autocorrelation value and LPC, voice is not accurately distinguished from noise in an environment of a bad S/N ratio. Further, if steady noise having a harmonic structure is input, the steady noise is wrongly determined to be voice.

The present invention has been made in view of these circumstances and is directed to provide a voice detecting apparatus capable of detecting input of human voice with high accuracy under more diversified environment.

Also, the present invention is directed to provide an automatic image pickup apparatus capable of accurately picking up an image of the direction of a speaker.

Further, the present invention is directed to provide a voice detecting method capable of detecting input of human voice with high accuracy under more diversified environment.

According to an embodiment of the present invention, there is provided a voice detecting apparatus for detecting whether human voice has been input based on an input voice signal. The voice detecting apparatus includes: a first determining unit configured to determine that human voice has been input if a signal component having a harmonic structure is detected from the input voice signal; a second determining unit configured to determine that human voice has been input if a frequency center-of-gravity of the input voice signal is within a predetermined frequency range; a noise level storing unit configured to store a noise level; a third determining unit configured to determine that human voice has been input if the ratio of the power of the input voice signal to the noise level stored in the noise level storing unit is above a predetermined threshold; a final determining unit configured to finally determine whether human voice has been input based on determination results of the first to third determining units; and a noise level updating unit configured to update the noise level stored in the noise level storing unit by using the power of the present input voice signal if the final determining unit determines that human voice has not been input.

In this voice detecting apparatus, the final determining unit finally determines whether human voice has been input based on the determination results of the first to third determining units. The first determining unit makes a determination by using a characteristic that human voice has a harmonic structure, and the second determining unit makes a determination by using a characteristic that the frequency center-of-gravity of human voice is in a predetermined range. The third determining unit makes a determination in accordance with change in the power of the input voice signal. The noise level used as a reference of the determination is updated by the noise level updating unit by using the power of the present input voice signal only if the final determining unit finally determines that human voice has not been input. Accordingly, the accuracy of the noise level increases and the determination accuracy of the third determining unit also increases.

According to another embodiment of the present invention, there is provided a voice detecting method for detecting whether human voice has been input based on an input voice signal. The voice detecting method includes the steps of: firstly determining that human voice has been input if a signal component having a harmonic structure is detected from the input voice signal; secondly determining that human voice has been input if a frequency center-of-gravity of the input voice signal is within a predetermined frequency range; thirdly determining that human voice has been input if the ratio of the power of the input voice signal to a noise level stored in a noise level storing unit is above a predetermined threshold; finally determining whether human voice has been input based on determination results obtained in the first to third determining steps; and updating the noise level stored in the noise level storing unit by using the power of the present input voice signal if the final determining step determines that human voice has not been input.

In this voice detecting method, whether human voice has been input is finally determined in the final determining step based on the determination results obtained in the first to third determining steps. In the first determining step, a determination is made by using a characteristic that human voice has a harmonic structure. In the second determining step, a determination is made by using a characteristic that the frequency center-of-gravity of human voice is in a predetermined range. In the third determining step, a determination is made in accordance with change in the power of the input voice signal. The noise level used as a reference of the determination is updated in the noise level updating step by using the power of the present input voice signal only if the final determining step finally determines that human voice has not been input. Accordingly, the accuracy of the noise level increases and the determination accuracy in the third determining step also increases.

In the voice detecting apparatus according to the embodiment of the present invention, whether human voice has been input is finally determined based on determination results obtained by the first determining unit that uses a characteristic of human voice of having a harmonic structure and the second determining unit that uses a characteristic that the frequency center-of-gravity of human voice is in a predetermined range, as well as on a determination result obtained by the third determining unit based on the power of an input voice signal. With this configuration, highly accurate determination can be made even under an environment of a bad S/N ratio. Further, since the third determining unit makes determination thereafter based on a noise level that is updated in accordance with the final determination result, the determination accuracy can be further increased.

In the voice detecting method according to the embodiment of the present invention, whether human voice has been input is finally determined based on determination results obtained in the first determining step that uses a characteristic of human voice of having a harmonic structure and the second determining step that uses a characteristic that the frequency center-of-gravity of human voice is in a predetermined range, as well as on a determination result obtained in the third determining step based on the power of an input voice signal. With this method, highly accurate determination can be made even under an environment of a bad S/N ratio. Further, since the third determining step makes determination thereafter based on a noise level that is updated in accordance with the final determination result, the determination accuracy can be further increased.

### BRIEF DESCRIPTION OF THE DRAWINGS

FIG. 1 shows an example of the entire configuration of a camera system according to an embodiment of the present invention;

FIG. 2 shows an example of the internal configuration of a direction detecting circuit;

FIG. 3 shows an example of the internal configuration of a voice detecting circuit;

FIG. 4 shows an example of the internal configuration of a harmonic structure detecting unit;

FIG. 5 shows an example of actual measurement of detection results in a case where the harmonic structure detecting unit is used and a case where a known voice detecting method is used;

FIG. 6 is a flowchart showing a process performed in the voice detecting circuit;

FIG. 7A shows an example of a power spectrum obtained by picking up male voice and FIG. 7B is an enlarged diagram thereof showing the range up to 1500 Hz; and

FIG. 8A shows an example of a power spectrum obtained by picking up fan noise and FIG. 8B is an enlarged diagram thereof showing the range up to 1500 Hz.

### DESCRIPTION OF THE PREFERRED EMBODIMENT

Hereinafter, an embodiment of the present invention is described in detail with reference to the drawings. This embodiment is described while assuming that the present invention is applied to a camera system used in a videoconference or the like.

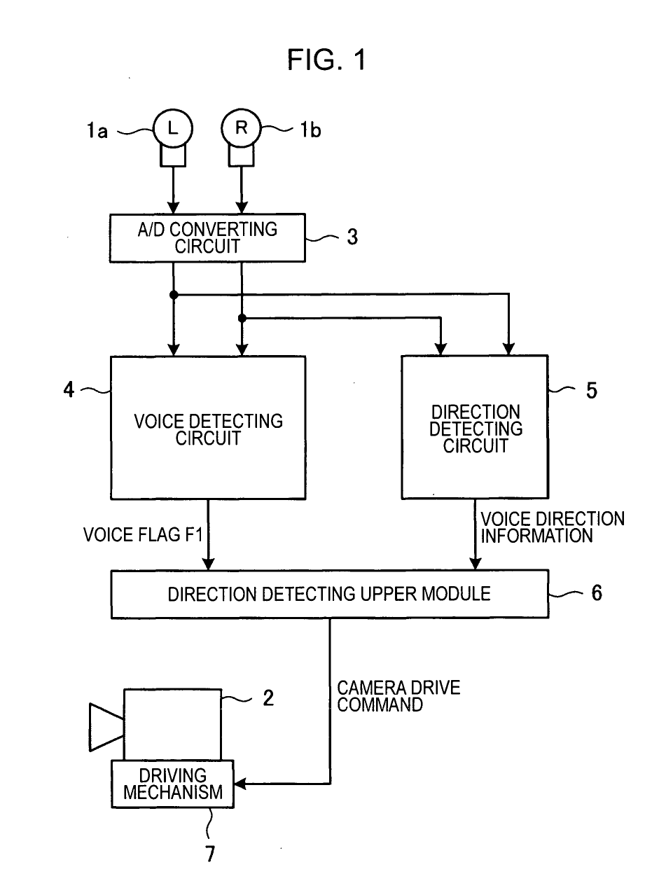

FIG. 1 shows an example of the entire configuration of the camera system according to the embodiment.

The camera system shown in FIG. 1 is a system of detecting a direction where voice is generated based on stereo voice signals input from microphones 1a and 1b and automatically directing a camera 2 toward a person who generated the voice. This camera system includes the microphones 1a and 1b, the camera 2, an A/D converting circuit 3 for input voice signals, a voice detecting circuit 4, a direction detecting circuit 5, a direction detecting upper module 6, and a driving mechanism 7 for the camera 2.

The A/D converting circuit 3 converts right and left voice signals input from the microphones 1a and 1b to digital signals at a sampling frequency of 16 kHz, for example, and outputs the digital signals to the voice detecting circuit 4 and the direction detecting circuit 5.

Based on the voice signals from the A/D converting circuit 3, the voice detecting circuit 4 determines whether the input voice is human voice or noise and then outputs a voice flag F1 as a determination result to the direction detecting upper module 6. If the input voice is determined to be human voice, the voice flag F1 is set to a H level. The direction detecting circuit 5 detects a direction in which the voice was generated based on the stereo voice signals from the A/D converting circuit 3 and outputs voice direction information as a detection result to the direction detecting upper module 6.

The direction detecting upper module 6 specifies the direction in which the voice was generated based on the voice flag F1 from the voice detecting circuit 4 and the voice direction information from the direction detecting circuit 5 and then outputs a camera drive command to the driving mechanism 7. More specifically, if the voice flag F1 indicates a H level only for a predetermined period (e.g., 300 ms) and if the voice direction information does not change during that period, the direction detecting upper module 6 determines that the direction (angle) is a direction in which the voice was generated and outputs a camera drive command in accordance with the direction. The driving mechanism 7 includes a motor mechanism to rotate the camera 2 and a driving circuit, and rotates the camera 2 so as to enable the camera 2 to pick up an image of the direction in response to the camera drive command.

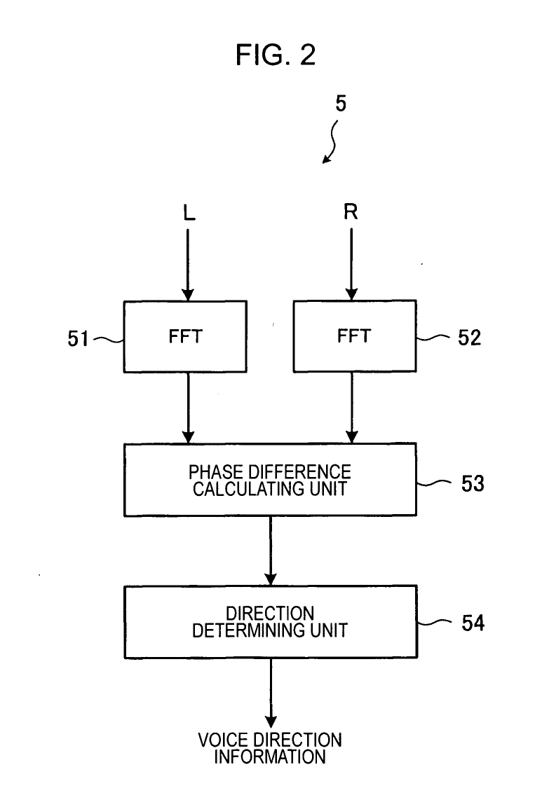

FIG. 2 shows an example of the internal configuration of the direction detecting circuit 5.

As shown in FIG. 2, the direction detecting circuit 5 includes FFT (fast Fourier transform) circuits 51 and 52, a phase difference calculating unit 53, and a direction determining unit 54. The FFT circuits 51 and 52 perform frequency analysis by using FFT operation on the right and left input voice signals from the A/D converting circuit 3 and output power spectra. The phase difference calculating unit 53 calculates a phase difference of each frequency band based on the right and left power spectra. The direction determining unit 54 converts the calculated phase difference of each frequency band into angle information in order to obtain a histogram of the angle, determines the direction in which the voice was generated based on the histogram, and then outputs voice direction information.

With the above-described configuration, the camera 2 is directed to the source of voice only when the input voice from the microphones 1a and 1b is human voice, so that an image of the speaker can be automatically picked up.

Next, a process of detecting human voice is described in detail.

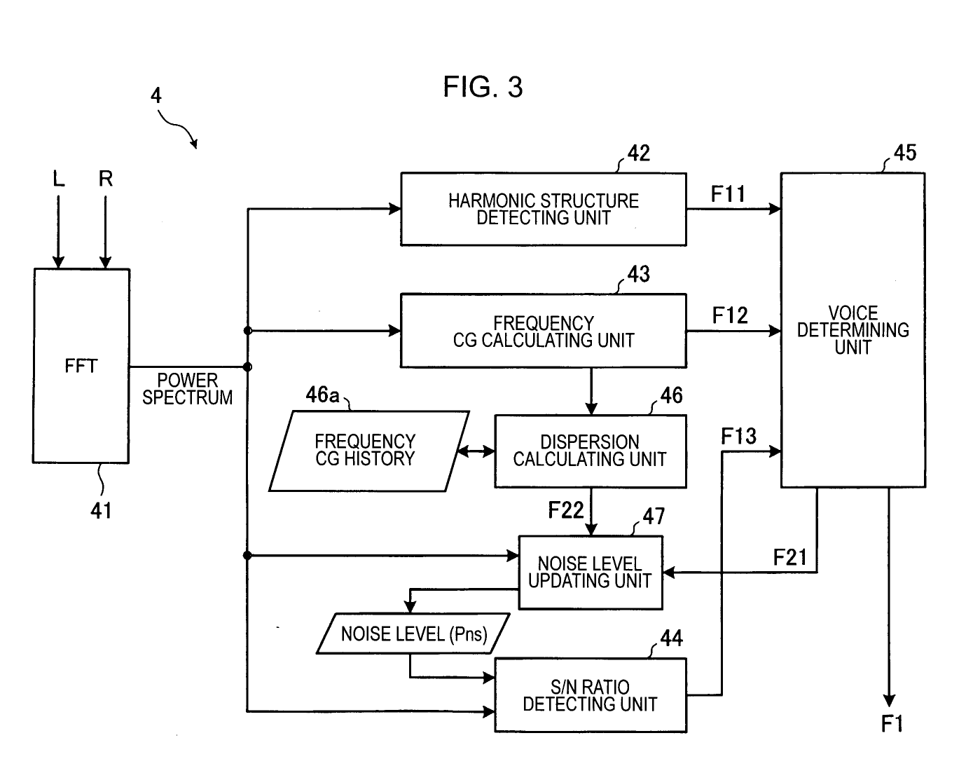

FIG. 3 shows an example of the internal configuration of the voice detecting circuit 4.

As shown in FIG. 3, the voice detecting circuit 4 includes an FFT circuit 41, a harmonic structure detecting unit 42, a frequency center-of-gravity (CG) calculating unit 43, an S/N ratio detecting unit 44, a voice determining unit 45, a dispersion calculating unit 46, and a noise level updating unit 47. These respective blocks are realized by software processing by a CPU (central processing unit) or the like, but part or all of the blocks may be realized by hardware. Also, the voice detecting circuit 4 includes a memory (not shown) such as a RAM (random access memory), which stores a noise level Pns and a frequency CG history 46a.

The FFT circuit 41 converts the stereo voice signal from the A/D converting circuit 3 to a monophonic signal and then performs frequency analysis by FFT operation every 16 ms, so as to output a power spectrum.

The harmonic structure detecting unit 42 calculates the ratio of the power of a harmonic component to the power of the input voice. Human voice (in particular, a vowel component) has a harmonic structure. Thus, if the ratio of the power of the harmonic component is higher than a predetermined value, the input voice is determined to be human voice and a determination flag F11 is set to a H level.

The frequency CG calculating unit 43 calculates the frequency CG of the input voice and determines whether the CG matches the frequency CG of human voice. Human voice includes more low frequency components compared to stationary noise such as white noise. Therefore, if the frequency CG of the input voice is within a predetermined range corresponding to human voice, the input voice is determined to be human voice and a determination flag F12 is set to a H level.

The S/N ratio detecting unit 44 compares the value of the power of the input voice based on the power spectrum from the FFT circuit 41 with the noise level Pns stored in the memory. If the difference therebetween is equal to or larger than a predetermined value, the S/N ratio detecting unit 44 determines that the input voice is human voice and sets a determination flag 13 to a H level.

The voice determining unit 45 is a block to make a final determination of the input voice. Specifically, the voice determining unit 45 receives input of the determination flags F11 to F13, determines the input voice to be human voice if all of the flags indicate a H level, sets the voice flag F1 to a H level, and sets an update flag F21 to a L level. When determining that the input voice is noise, the voice determining unit 45 sets the voice flag F1 to a L level and sets the update flag F21 to a H level.

The dispersion calculating unit 46 constantly holds the history (frequency CG history 46a) of detected values of the frequency CG that are calculated by the frequency CG calculating unit 43 during a past predetermined period (e.g., 100 ms to 200 ms). Also, when obtaining a detected value of the frequency CG calculated by the frequency CG calculating unit 43, the dispersion calculating unit 46 calculates the dispersion of the frequency CG of the period based on the detected value and the frequency CG history 46a of the past predetermined period. If the value of dispersion is equal to or smaller than a predetermined value, the dispersion calculating unit 46 determines that the input voice is noise and sets an update flag F22 to a L level.

The noise level updating unit 47 updates the noise level Pns stored in the memory by using the power value of the input voice based on the power spectrum from the FFT circuit 41. The noise level updating unit 47 updates the noise level Pns when both of the update flags F21 and F22 from the voice determining unit 45 and the dispersion calculating unit 46 are set to a H level.

In the voice detecting circuit 4, the accuracy of voice detection is enhanced by using a voice detecting method based on the power of input voice and using the noise level Pns that is updated as necessary and a method of detecting a feature amount based on values except the power of input voice, that is, a feature amount based on a result of frequency analysis obtained by detection of a harmonic structure and calculation of a frequency CG. In the voice detection based on the power of input voice, the noise level Pns is updated only if the input voice is determined to be noise based on a final determination result using the above-described methods, so that the accuracy of the noise level Pns is enhanced. Further, by determining whether the noise level Pns can be updated in accordance with the dispersion of the frequency CG in a predetermined period, the accuracy of the noise level Pns can be further enhanced.

Hereinafter, each detecting function used in this embodiment is described in detail.

<1> Detection of a Harmonic Structure

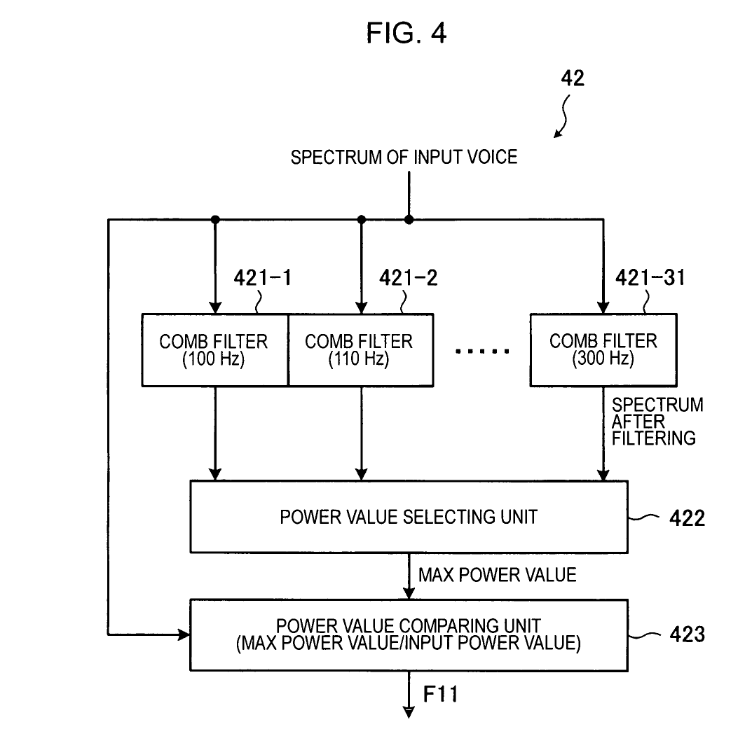

FIG. 4 shows an example of the internal configuration of the harmonic structure detecting unit 42.

As shown in FIG. 4, the harmonic structure detecting unit 42 includes a plurality of comb filters 421-1 to 421-31 having different fundamental frequencies, a power value selecting unit 422, and a power value comparing unit 423.

The comb filters 421-1 to 421-31 are filters to receive the power spectrum from the FFT circuit 41 and to pass a signal component of a predetermined fundamental frequency in the frequency band of human voice (100 Hz to 300 Hz in this case) and its harmonic component. In this example, thirty one comb filters 421-1 to 421-31, whose fundamental frequencies are different from each other by 10 Hz in the above-mentioned frequency band, are provided.

The power value selecting unit 422 selects a maximum value from among power values of output signals from the comb filters 421-1 to 421-31. The power value comparing unit 423 calculates the ratio between the selected maximum power value and the power value of the input voice based on the power spectrum from the FFT circuit 41 (maximum power value/input power value). If the ratio is above a predetermined threshold, the power value comparing unit 423 sets the determination flag F11 to a H level. If the ratio is equal to a smaller than the threshold, the determination flag F11 is set to a L level.

In this harmonic structure detecting unit 42, if a voice having a harmonic structure, such as vowel of human voice, is input, at least one of output values of the comb filters 421-1 to 421-31 is large. Conversely, if a voice not having a harmonic structure, such as noise of an air conditioner, is input, the output value of every filter is relatively small. Therefore, when the ratio of the maximum power value of filter output to the input power value is higher than the threshold, it is determined that the input voice is human voice with a high probability and the determination flag is set to a H level. In this way, by using a criterion of whether a signal component of a specific frequency band has a harmonic structure, human voice can be detected with high accuracy compared to a method of detecting human voice based on the power of input voice.

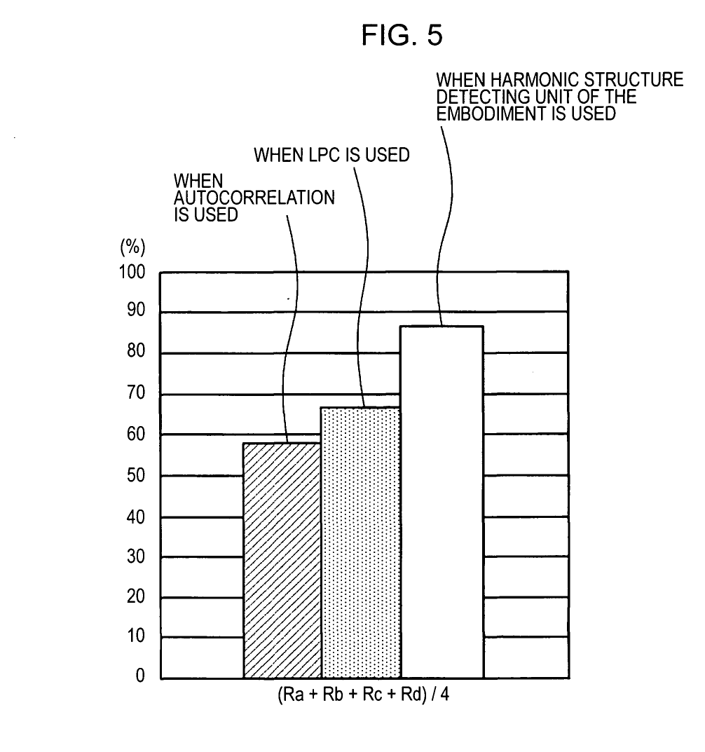

FIG. 5 shows an example of actual measurement of detection results obtained in a case where the harmonic structure detecting unit 42 is used and a case where the known voice detecting method is used.

In FIG. 5, male voice, female voice, white noise, and stationary noise of a room are applied as input voice. Under this condition, an average of probabilities Ra, Rb, Rc, and Rd of accurately distinguishing human voice from noise is shown. Also, a case where autocorrelation of input voice is used and a case where LPC is used are shown as the known methods. As shown in FIG. 5, by using the harmonic structure detecting unit 42 of this embodiment having comb filters, human voice can be distinguished from noise with a higher probability compared to the known methods using autocorrelation and LPC, respectively.

<2> Calculation of Frequency CG

The frequency CG calculating unit 43 receives input of the power spectrum from the FFT circuit 41 and calculates a frequency CG “c” by using the following equation (1). Note that the power of a signal component of a frequency “f” is represented by “p(f)”.

$$\begin{matrix}[ Equation 1 ] & \\ c = \frac{{\sum }_{f} p ( f ) \times f}{{\sum }_{f} p ( f )} & ( 1 )\end{matrix}$$

In equation 1, the frequency CG “c” becomes low if voice in which the power of a relatively low-frequency signal component is large is input. The frequency CG “c” becomes high if voice in which the power of a high-frequency signal component is large is input. The value of the frequency CG “c” is about 300 Hz to 1200 Hz in human voice (vowel), whereas the value is often 2000 Hz or more in fan noise of an air conditioner or the like and is 3000 Hz or more in noise including many relatively high-frequency components, such as a sound of turning over paper or a sound of hand clapping.

Therefore, when the calculated frequency CG “c” is in the range of 300 Hz to 1200 Hz, the frequency CG calculating unit 43 determines that the input voice is human voice with a high probability and sets the determination flag F12 to a H level. Accordingly, the above-described each type of noise can be distinguished from human noise with higher accuracy compared to the method of detecting human voice based on the power of input voice.

<3> Detection of S/N Ratio and Update of Noise Level

The S/N ratio detecting unit 44 detects input of voice when detecting relatively large input voice with reference to the value of the noise level Pns stored in the memory. More specifically, the S/N ratio detecting unit 44 calculates the power value Pin of the input voice based on the power spectrum from the FFT circuit 41 so as to obtain an S/N ratio, that is, the ratio between the power value Pin and the noise level Pns in the memory (Pin/Pns). If the S/N ratio is above a predetermined threshold, the S/N ratio detecting unit 44 sets the determination flag F13 to a H level.

The noise level Pns is updated as necessary by the noise level updating unit 47. The noise level updating unit 47 calculates a new noise level Pns by using the power value Pin of the input voice based on the power spectrum and a coefficient α (0<α<1) and using an expression: (1−α)×(present noise level Pns)+α×(power value Pin of input voice), and then overwrites the memory.

If the noise level Pns is constantly updated at predetermined intervals as in the known art and if human voice or noise larger than stationary noise is input, the value of the noise level becomes extraordinarily large and the detection accuracy thereafter decreases. On the other hand, in this embodiment, the noise level Pns is updated only when the input voice is determined to be noise based on the determination result generated by the voice determining unit 45 and the dispersion calculating unit 46. Accordingly, the accuracy of the noise level Pns increases and thus the detection accuracy in the S/N ratio detecting unit 44 increases.

During a predetermined period just after voice detection started, the S/N ratio detecting unit 44 wrongly determines that input voice is noise regardless of the type of the input voice. However, after the predetermined period has elapsed, the noise level Pns converges to the level of stationary noise and the detection accuracy in the S/N ratio detecting unit 44 becomes high. In this embodiment, the noise level Pns is updated only when input voice is determined to be noise by the voice determining unit 45 and the dispersion calculating unit 46, so that the time required for convergence of the noise level Pns can be shortened.

<4> Dispersion of Frequency CG

Some stationary noise has a frequency band approximate to that of human voice and also has a harmonic structure. Therefore, when such noise is input, the noise may be wrongly determined to be human voice even if the determination is made by the harmonic structure detecting unit 42 and the frequency CG calculating unit 43. The dispersion calculating unit 46 is provided to prevent such a wrong determination of noise.

In typical human voice, many types of vowels and consonants appear one after another, so that the frequency CG thereof significantly changes in a short time. On the other hand, in stationary noise, change in power in a frequency band of large power is small and thus change in frequency CG is also small. Based on this principle, by calculating dispersion of the frequency CG during a past predetermined period (e.g., 100 ms to 200 ms), input voice can be determined. That is, when the dispersion is relatively small, the input voice has a high possibility of being stationary noise.

Every time receiving a value of the frequency CG from the frequency CG calculating unit 43, the dispersion calculating unit 46 updates the frequency CG history 46a of a predetermined period and calculates dispersion of the value in the frequency CG history 46a. If the value of dispersion is equal to or smaller than a predetermined threshold (e.g., 50 Hz), the dispersion calculating unit 46 determines that the input voice is noise and sets the update flag F22 to a H level. Accordingly, stationary noise having a harmonic structure can be accurately determined and the determination can be reflected to the detection result in the S/N ratio detecting unit 44.

Now, an entire process of detecting voice using the above-described detecting functions is described.

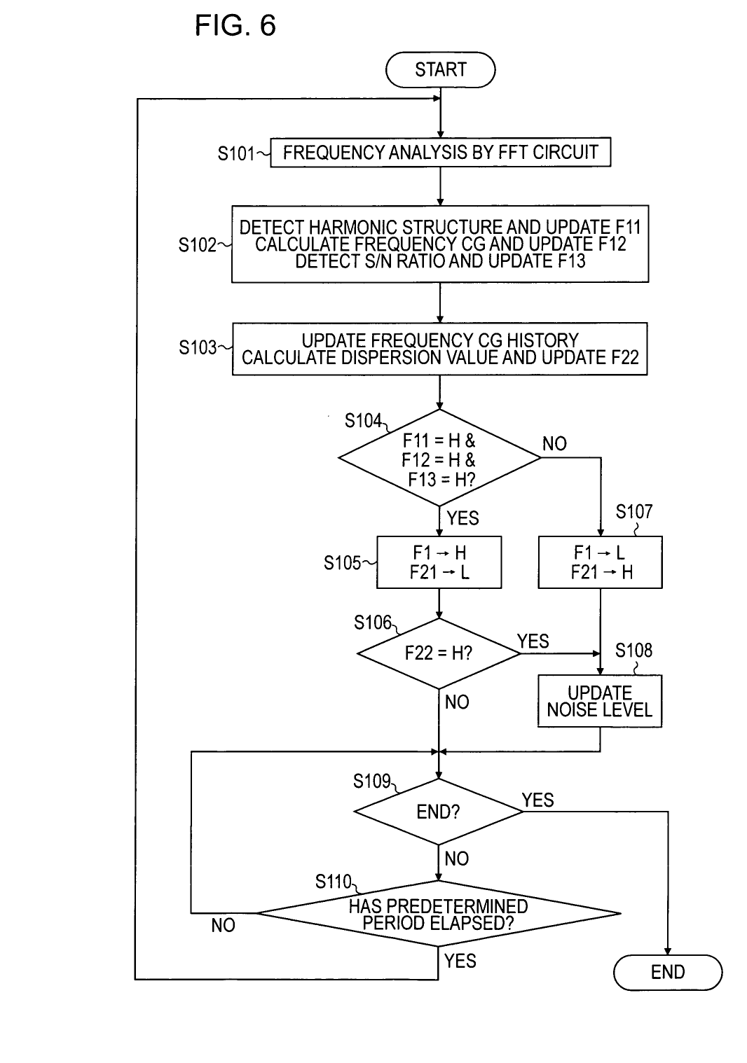

FIG. 6 is a flowchart showing the process performed in the voice detecting circuit 4.

The voice detecting circuit 4 performs the process at predetermined intervals (every 16 ms in this case). First, the FFT circuit 41 performs frequency analysis on an input signal and outputs a power spectrum (step S101). Then, the harmonic structure detecting unit 42, the frequency CG calculating unit 43, and the S/N ratio detecting unit 44 receive the power spectrum, perform the above-described detection/calculation, and update the determination flags F11 to F13 in accordance with generated results (step S102). Further, the dispersion calculating unit 46 obtains the value of the frequency CG calculated by the frequency CG calculating unit 43 and updates the frequency CG history 46a. Then, the dispersion calculating unit 46 calculates a dispersion value and updates the update flag F22 in accordance with the calculation result (step S103).

Then, the voice determining unit 45 makes determination in accordance with the determination flags F11 to F13 (step S104). If all of these flags indicate a H level, the voice determining unit 45 determines that the input voice is human voice and sets the voice flag F1 to a H level and the update flag F21 to a L level (step S105). Then, the noise level updating unit 47 refers to the update flags F21 and F22 (step S106). If both of the flags F21 and F22 indicate a L level, the noise level updating unit 47 does not update the noise level Pns and waits. If the update flag F22 is set to a H level, the noise level updating unit 47 updates the value of the noise level Pns (step S108).

On the other hand, if any one of the determination flags F11 to F13 indicates a L level, the voice determining unit 45 determines that the input voice is not human voice but noise, and sets the voice flag F1 to a L level and the update flag F21 to a H level (step S107). Then, the noise level updating unit 47 detects that the update flag F21 is set to a H level and updates the value of the noise level Pns (step S108).

In the above-described process, the voice determining unit 45 finally determines that the input voice is human voice if all of the determination flags F11 to F13 are set to a H level. The noise level Pns is updated by the noise level updating unit 47 if any one of the update flags F21 and F22 is set to a H level.

Then, the voice detecting circuit 4 determines whether end of the voice detecting process is requested by a user's input operation, for example (step S109). If end of the process is requested, the process ends. If end of the process is not requested, the process waits for an end request (corresponding to step S109) until the above-mentioned predetermined period elapses, and then the process returns to step S101 after the predetermined period has elapsed (step S110). Accordingly, the FFT circuit 41 performs frequency analysis again.

As described above, in this embodiment, (1) the voice detecting method based on the power of input voice realized by the S/N ratio detecting unit 44; and (2) the method of detecting a feature amount (harmonic structure and frequency CG) based on a frequency analysis result realized by the harmonic structure detecting unit 42 and the frequency CG calculating unit 43 are used together, and the voice determining unit 45 makes a final determination based on all of these determination results. Accordingly, voice can be detected with higher accuracy even in an environment of large noise.

Furthermore, since the noise level updating unit 47 updates the noise level Pns when the voice determining unit 45 determines that the input voice is noise, a detection accuracy improving effect due to detection of a feature amount based on a frequency analysis result is fed back to the detection accuracy of the S/N ratio detecting unit 44. In other words, the accuracy of the noise level Pns is higher than a case where the noise level Pns is updated based on the power of input voice. As a result, the S/N ratio detecting unit 44 does not make a wrong determination even if stationary noise is input or if the same person continues to speak for a long time. Accordingly, the entire detection accuracy can be increased.

Still further, the noise level updating unit 47 updates the noise level Pns also when the dispersion calculating unit 46 determines that the input voice is noise. Therefore, the noise level Pns is updated when stationary noise that has a frequency band approximate to that of human voice and that has a harmonic structure is input. Accordingly, the detection accuracy of the S/N ratio detecting unit 44 further increases and the entire detection accuracy can also increase. That is, even the noise that cannot be determined by the harmonic structure detecting unit 42 and the frequency CG calculating unit 43 can be detected.

Accordingly, human voice can be accurately detected regardless of a place where voice is detected, a position of an ambient noise source, or a distance to a speaker. Also, since the accuracy of the noise level Pns increases, an accurate detection can be performed at an early stage just after voice detection started, which enhances the usability.

Next, specific examples of voice detection are described. In the following examples, the threshold in the harmonic structure detecting unit 42 is set to 0.3, the frequency band in which input voice is determined to be human voice by the frequency CG calculating unit 43 is set to 300 Hz to 1200 Hz, and the threshold in the S/N ratio detecting unit 44 is set to 5 dB.

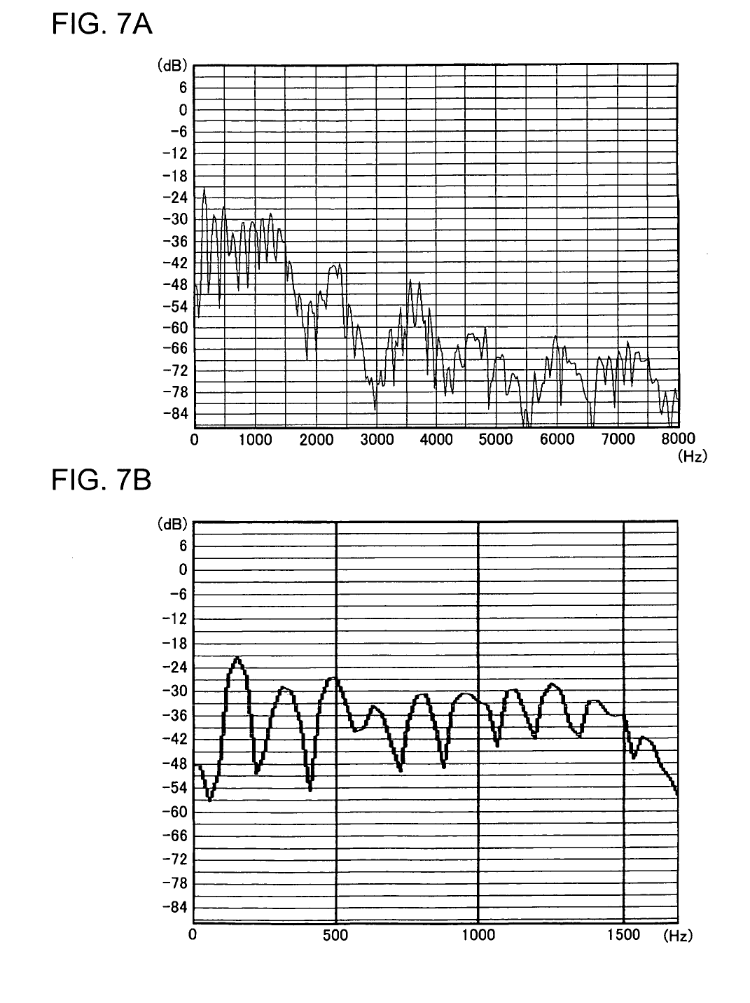

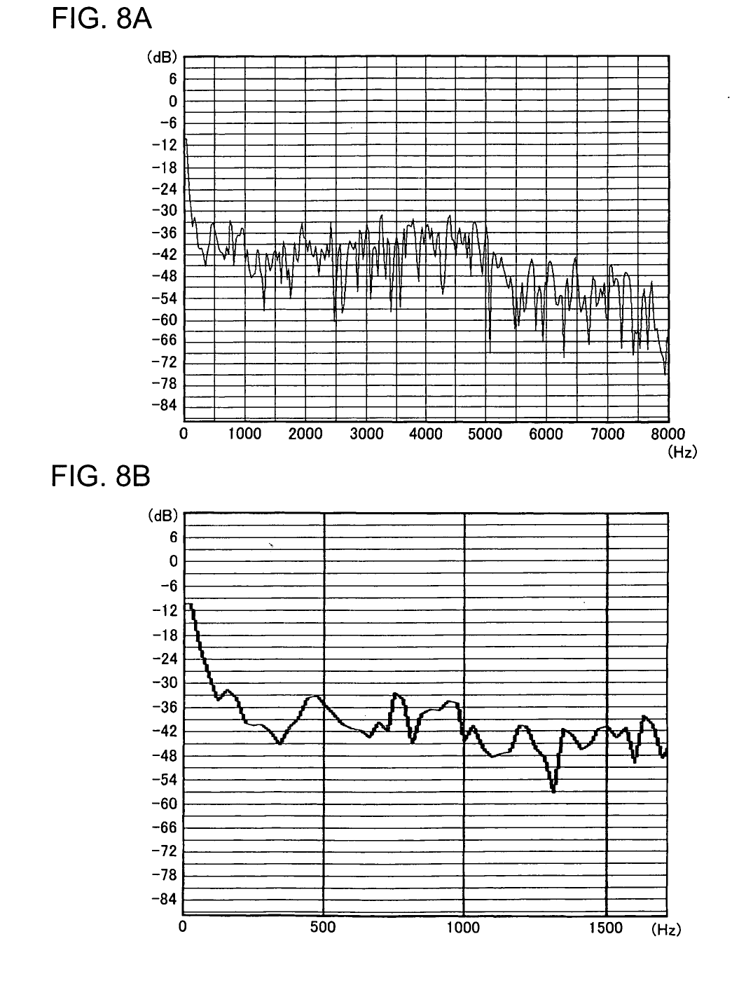

FIGS. 7A and 7B show an example of the power spectrum obtained when male voice is picked up. FIGS. 8A and 8B show an example of the power spectrum obtained when fan noise is picked up. FIGS. 7B and 8B are enlarged diagrams showing the spectrum in a range of 0 Hz to 1500 Hz of FIGS. 7A and 8A, respectively.

In the example shown in FIGS. 7A and 7B, the level is high in the band up to 1500 Hz. In this bandwidth, a harmonic component based on a frequency of 160 Hz is included, and a comb filter corresponding to this fundamental frequency is selected in the harmonic structure detecting unit 42. At this time, the value calculated by the power value comparing unit 423 of the harmonic structure detecting unit 42 is 0.4, the frequency CG calculated by the frequency CG calculating unit 43 is 800 Hz, and the S/N ratio detected by the S/N ratio detecting unit 44 is 10 dB, so that all of the determination flags F11 to F13 are set to a H level. Accordingly, the input voice is correctly determined to be human voice.

On the other hand, FIGS. 8A and 8B show an example of detecting fan noise, which is stationary noise that does not have a harmonic structure. In this example, the value calculated by the power value comparing unit 423 of the harmonic structure detecting unit 42 is 0.2, the frequency CG is 3000 Hz, and the S/N ratio is 6 dB. Since the power of the fan noise is relatively large, only the determination flag F13 is set to a H level. In this case, wrong detection occurs if only the power of the input voice is used in detection. In this embodiment, however, a feature amount is detected based on the frequency analysis result, so that the input voice is correctly determined to be noise.

Hereinafter, a detection example in a case where stationary noise having a harmonic structure is input is described. In this example, the value calculated by the power value comparing unit 423 of the harmonic structure detecting unit 42 is 0.3, the frequency CG is 1000 Hz, and the S/N ratio is 5 dB just after input. Therefore, all of the determination flags F11 to F13 are set to a H level and thus the input voice is wrongly determined to be human voice. However, since the frequency CG does not change, the dispersion value calculated by the dispersion calculating unit 46 becomes small. Then, after several hundreds of ms has elapsed, the dispersion value is accurately calculated. Thus, the S/N ratio decreases to 1 dB and the determination flag F13 is set to a L level, so that the input voice is correctly determined to be noise.

As described above, the voice detecting circuit 4 according to this embodiment is capable of accurately detecting human voice. Therefore, the camera system using this voice detecting circuit 4 is capable of automatically directing the camera 2 to a speaker and accurately picking up an image of the speaker.

This camera system can be applied to a videoconference system, which enables a conference in remote places, by mutually transmitting/receiving image signals generated by a camera and picked up voice signals through a communication line. In the videoconference system using the camera system according to this embodiment, anyone can smoothly talk to the other party through a communication line. Further, only voice signals including human voice can be transmitted through the line based on the detection result of the voice detecting circuit 4. In other words, voice signals are not transmitted to the other party when only noise is input. In that case, unnecessary noise is not played back on the other side, so that attendees can concentrate attention on the conference.

In the above-described embodiment, input voice is determined to be human voice if all of the determination flags F11 to F13 indicate a H level. However, the present invention is not limited to this method, but input voice may be determined to be human voice if one or two of the determination flags indicate a H level. In this case, too, the accuracy of voice detection can be increased compared to the known art. Further, the voice determining unit 45 may make a final determination based on the update flag F22 in addition to the determination flags F11 to F13.

In the above-described camera system, one camera is directed toward a speaker. Alternatively, a plurality of fixed cameras may be placed. In that case, signals from the cameras are switched in accordance with the detection result of the voice detecting circuit 4 and the determination result of the direction determining unit 54.

The above-described voice detecting method can be applied to other systems, such as a security camera system. In the security camera system, for example, when a voice is generated in a place where anyone cannot exist, an image of the place is automatically picked up by a camera. The voice detecting method can also be applied to a system of picking up an image of a position where an extraordinarily loud sound or a specific sound, such as footsteps, as well as human voice occurs. In the latter case, the threshold used in voice detection is changed or the combination of determination flags used in a final determination is changed in accordance with the characteristic of voice to be detected.

It should be understood by those skilled in the art that various modifications, combinations, sub-combinations and alterations may occur depending on design requirements and other factors insofar as they are within the scope of the appended claims or the equivalents thereof.

What is claimed is:

1. A voice detecting apparatus for detecting whether human voice has been input based on an input voice signal, the voice-detecting apparatus comprising:
a first determining unit configured to determine that human voice has been input if a signal component having a harmonic structure is detected from the input voice signal;
a second determining unit configured to determine that human voice has been input if a frequency center-of-gravity of the input voice signal is within a predetermined frequency range;
a noise level storing unit configured to store a noise level;
a third determining unit configured to determine that human voice has been input if the ratio of the power of the input voice signal to the noise level stored in the noise level storing unit is above a predetermined threshold;
a final determining unit configured to finally determine whether human voice has been input based on determination results of the first to third determining units; and
a noise level updating unit configured to update the noise level stored in the noise level storing unit by using the power of the present input voice signal if the final determining unit determines that human voice has not been input.

2. The voice detecting apparatus according to claim 1, wherein the first determining unit comprises:
an extracting unit configured to extract a signal component having a harmonic structure from the input voice signal; and
a comparing unit configured to compare the power of the extracted signal component with the power of at least a non-harmonic component of the input voice signal and determine that human voice has been input if the power ratio of the signal component is above a predetermined threshold.

3. The voice detecting apparatus according to claim 2, wherein the extracting unit comprises:
a plurality of filters configured to pass a signal component of a fundamental frequency and a harmonic component of the input voice signal, different fundamental frequencies being set to the respective filters; and
a selecting unit configured to select an output signal having a maximum power from among output signals from the respective filters.

4. The voice detecting apparatus according to claim 1, wherein the noise level updating unit updates the noise level by combining the noise level stored in the noise level storing unit and the power of the present input voice signal with a predetermined ratio.

5. The voice detecting apparatus according to claim 1, wherein the final determining unit finally determines that human voice has been input if all of the first to third determining units determine that human voice has been input.

6. The voice detecting apparatus according to claim 1, further comprising:
a fourth determining unit configured to calculate dispersion of the frequency center-of-gravity that is calculated by the second determining unit in a predetermined period from the past to the present and determine that human voice has not been input if the calculated dispersion value is equal to or under a predetermined threshold,
wherein the noise level updating unit updates the noise level stored in the noise level storing unit if at least one of the final determining unit and the fourth determining unit determines that human voice has not been input.

7. An automatic image pickup apparatus for automatically picking up an image of a direction of a speaker by a camera, the automatic image pickup apparatus comprising:
a plurality of voice pickup units;
a direction detecting unit configured to detect a direction of a speaker based on an input voice signal from the voice pickup units;
a voice detecting unit including
a first determining unit configured to determine that human voice has been input if a signal component having a harmonic structure is detected from the input voice signal,
a second determining unit configured to determine that human voice has been input if a frequency center-of-gravity of the input voice signal is within a predetermined frequency range,
a noise level storing unit configured to store a noise level,
a third determining unit configured to determine that human voice has been input if the ratio of the power of the input voice signal to the noise level stored in the noise level storing unit is above a predetermined threshold,
a final determining unit configured to finally determine whether human voice has been input based on determination results of the first to third determining units, and
a noise level updating unit configured to update the noise level stored in the noise level storing unit by using the power of the present input voice signal if the final determining unit determines that human voice has not been input; and
a driving unit configured to change a pickup direction of the camera in accordance with each detection result of the direction detecting unit and the voice detecting unit.

8. A voice detecting method for detecting whether human voice has been input based on an input voice signal, the voice detecting method comprising the steps of:
firstly determining that human voice has been input if a signal component having a harmonic structure is detected from the input voice signal;
secondly determining that human voice has been input if a frequency center-of-gravity of the input voice signal is within a predetermined frequency range;
thirdly determining that human voice has been input if the ratio of the power of the input voice signal to a noise level stored in a noise level storing unit is above a predetermined threshold;
finally determining whether human voice has been input based on determination results obtained in the first to third determining steps; and
updating the noise level stored in the noise level storing unit by using the power of the present input voice signal if the final determining step determines that human voice has not been input.
